(19) United States
(12) Patent Application Publication
(10) Pub. No.: US 2010/0053704 A1
(43) Pub. Date: Mar. 4, 2010

(54) DUPLEX SCAN APPARATUS

(75) Inventor: Hsing-Lu CHEN, Hsinchu City (TW)

Correspondence Address: RABIN & Berdo, PC, 1101 14TH STREET, NW, SUITE 500, WASHINGTON, DC, 20005, US

(73) Assignee: AVISION INC., Hsinchu (TW)

(21) Appl. No.: 12/614,066

(22) Filed: Nov. 6, 2009

Related U.S. Application Data
(63) Continuation-in-part of application No. 11/273,028, filed on Nov. 15, 2005.

(30) Foreign Application Priority Data
Nov. 15, 2004 (TW) 93134989

(51) Int. Cl. H04N 1/04

(52) U.S. Cl. 358/483

(57) ABSTRACT

A duplex scan apparatus for generating scanned images of a resolution includes an ASIC, a first CCD, a second CCD, a first AFE, and a second AFE. The ASIC processes digital data at an ASIC timing and outputs a CCD timing, wherein the ASIC timing equals twice as the resolution. The first CCD scans the first face of a document and generates first analog data according to the CCD timing. The second CCD scans the second face of the document and generates second analog data according to the CCD timing. The first AFE converts the first analog data into first digital data and outputs a first data amount of data points of the digital data to the ASIC for processing. The second AFE converts the second analog data into second digital data and outputs a second data amount of data points of the digital data to the ASIC for processing.

This application is a continuation-in-part application of application Ser. No. 11/273,028, filed Nov. 15, 2005, and claims the benefit of Taiwan application Serial No. 93134989, filed Nov. 15, 2004, the subject matter of which is incorporated herein by reference.

### BACKGROUND OF THE INVENTION

1. Field of the Invention

The invention relates in general to a duplex scan apparatus, and more particularly to a duplex scan apparatus, using a single application specific integrated circuit (ASIC) to simultaneously process the image data generated in duplex scan.

2. Description of the Related Art

FIG. 1 is a partial block diagram of a conventional duplex scanner. Referring to FIG. 1, the duplex scanner 100 includes a first ASIC 110, a second ASIC 120, a first analog front end (AFE) 112, a second AFE 122, a first charge coupled device (CCD) 114 and a second CCD 124. The CCDs 114 and 124 scan the first face and the second face of a to-be-scanned document (not shown in the figure) respectively and generate first analog data Di1 and second analog data Di2 according to a timing T1 and a timing T2 correspondingly outputted by the ASICs 110 and 120. The first AFE 112 and second AFE 122 convert the first analog data Di1 and the second analog data Di2 into first digital data Da1 and second digital data Da2, and transmit the first digital data Da1 and the second digital data Da2 to the ASICs 110 and 120 for data processing.

For example, the ASICs 110 and 120 output the timing T1 and T2 of 1200 dpi respectively. The CCDs 114 and 124 capture first analog data Di1 of 1200 dpi and second analog data Di2 of 1200 dpi respectively for the first face and the second face of the to-be-scanned document according to the timings T1 and T2. The duplex image scan requires two ASICs to process image data captured by two CCDs and transmit processed image data to a computer, which increases manufacturing cost.

### SUMMARY OF THE INVENTION

It is therefore an object of the invention to provide a duplex scan apparatus. By using a single ASIC to simultaneously process the image data generated in duplex scan, the manufacturing cost can be effectively reduced.

The invention achieves the above-identified object by providing a duplex scan apparatus for simultaneously scanning a first face and a second face of a to-be-scanned document to generate scanned images of a selected resolution. The duplex scan apparatus includes an ASIC, a first CCD, a second CCD, a first AFE, and a second AFE. The ASIC processes digital data at an ASIC timing and outputs a CCD timing, wherein the ASIC timing equals twice as the selected resolution. The first CCD controlled by the ASIC scans the first face of the to-be-scanned document and generates first analog data according to the CCD timing outputted by the ASIC. The second CCD controlled by the ASIC scans the second face of the to-be-scanned document and generates second analog data according to the CCD timing outputted by the ASIC. The first AFE coupled with the first CCD and the ASIC converts the first analog data into first digital data and outputs a first data amount of data points of the first digital data to the ASIC for processing. The second AFE coupled with the second CCD and the ASIC converts the second analog data into second digital data and outputs a second data amount of data points of the second digital data to the ASIC for processing. Therefore, using a single ASIC to process simultaneously the image data of two CCDs can effectively reduce the cost.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a partial block diagram of a conventional duplex scanner.

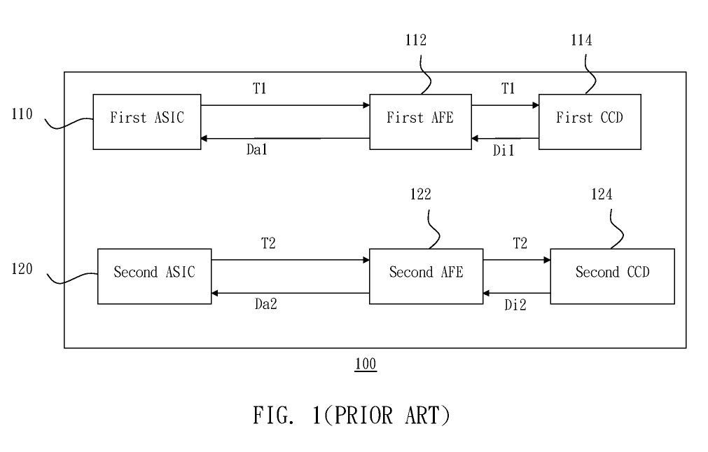

FIG. 2 is a partial block diagram of a duplex scan apparatus according to a preferred embodiment of the invention.

FIG. 3 is a schematic diagram showing the time for processing the first and second digital data outputted by two AFEs by using a single ASIC.

FIG. 4 illustrates the output of the first and second digital data controlled by the output enable signals and the sequence of the first and second digital data processed by the ASIC according to the ASIC timing, according to the preferred embodiment of the invention.

### DETAILED DESCRIPTION OF THE INVENTION

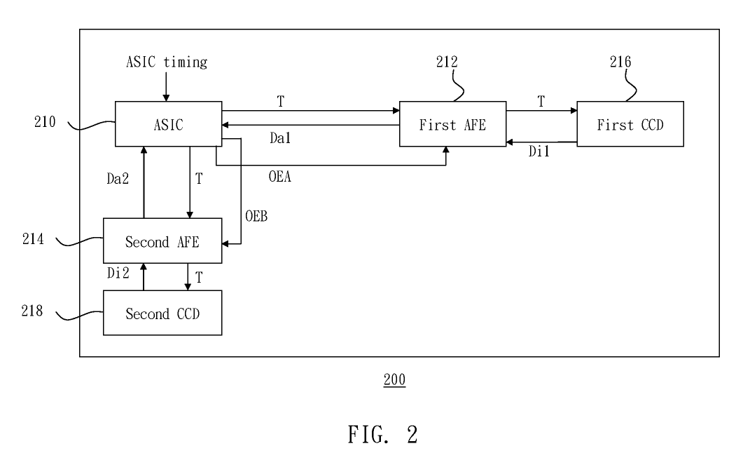

Referring to FIG. 2, a partial block diagram of a duplex scan apparatus according to a preferred embodiment of the invention is shown. The duplex scan apparatus 200 includes an ASIC 210, a first AFE 212, a second AFE 214, a first CCD 216 and a second CCD 218. The ASIC 210 processes digital data and outputs a CCD timing T to the first CCD 216 and the second CCD 218, a first output enable signal OEA to the first AFE 212 and a second output enable signal OEB to the second AFE 214. The first CCD 216 scans a first face of a to-be-scanned document (not shown in the figure) on a line-to-line basis and generates first analog data Di1 according to the CCD timing T. The second CCD 218 scans a second face of the to-be-scanned document on a line-to-line basis and generates second analog data Di2 according to the CCD timing T. The first AFE 212 converts the first analog data Di1 into first digital data Da1 and the second AFE 214 converts the second analog data Di2 into second digital data Da2. The first AFE 212 outputs the entirety or a portion of the first digital data Da1 to the ASIC 210 according to the first output enable signal OEA. The second AFE 214 outputs the entirety or a portion of the second digital data Da2 to the ASIC 210 according to the second output enable signal OEB. The first digital data Da1 and the second digital data Da2 transmitted to the ASIC 210 for data processing are constituted by data points of a first data amount and a second data amount respectively.

Different from the prior art, the invention uses a single ASIC 210 to process the first digital data Da1 and the second digital data Da2. In this example, the ASIC 210 has a capability to process digital data at an ASIC timing of 1200 dpi. For a duplex scan to generate scanned images of a selected resolution of 600 dpi, the ASIC 210 outputs the CCD timing T of 1200 dpi, which equals twice as the selected resolution of the scanned images, to the first CCD 216 and the second CCD 218 respectively to control the first CCD 216 and the second CCD 218 to generate the first analog data Di1 of 1200 dpi and the second analog data Di2 of 1200 dpi respectively. Assuming that at 1200 dpi each scan line contains 1200 data points, each of the first analog data Di1 and the second analog data Di2 is constituted by 1200 data points. The first AFE 212 and the second AFE 214 convert the analog data Di1 and Di2 of 1200 dpi into the first digital data Da1 of 1200 dpi and the second digital data Da2 of 1200 dpi respectively. The output enable signals OEA and OEB outputted by the ASIC 210 enable the first AFE 212 and the second AFE 214 to transmit 600 data points of the first digital data Da1 and 600 data points of the second digital data Da2 to the ASIC 210 for data processing. The output enable signals OEA and OEB control the output of the digital data Da1 and Da2 from the AFEs 212 and 214.

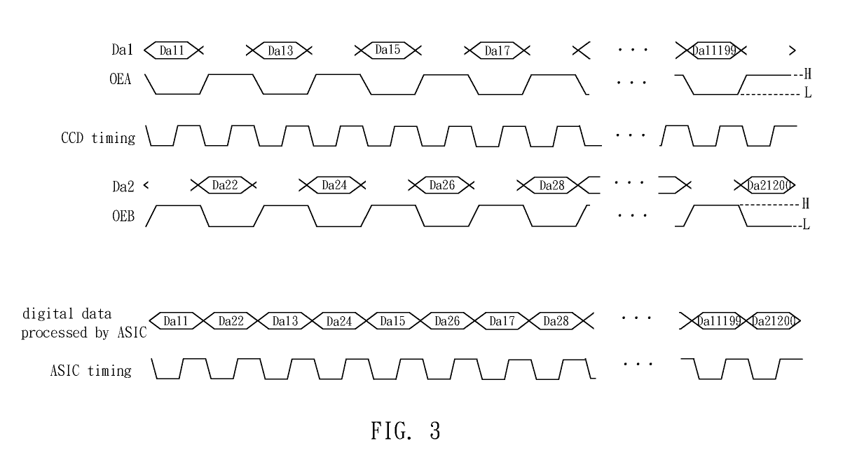

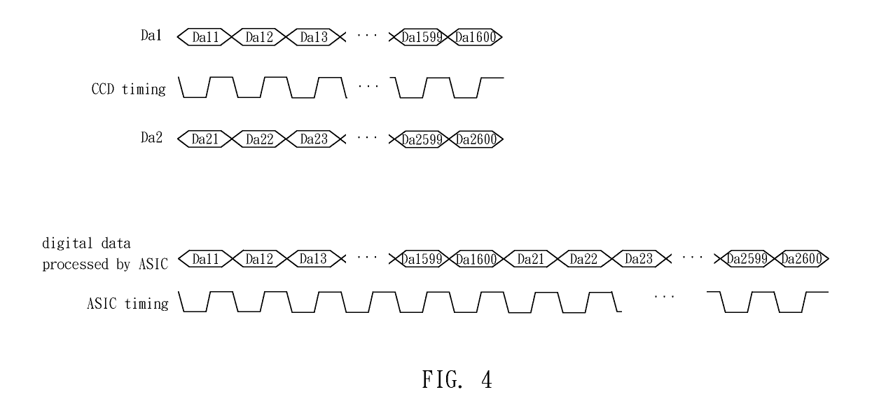

In one embodiment, referring to FIG. 4, the ASIC 210 outputs the output enable signals OEA and OEB to enable the first AFE 212 and the second AFE 214 to transmit 600 odd-numbered data points of the first digital data Da1 and 600 even-numbered data points of the second digital data Da2 to the ASIC 210. Subsequently, the ASIC 210 processes the digital data in, for instance, the following sequence, Da11, Da22, Da13, Da24, Da15, Da26, . . . , Da11199, Da21200. Referring to FIG. 3, the ASIC 210 processes the 600 odd-numbered data points of the first digital data Da1 and the 600 even-numbered data points of the second digital data Da2 as if it were processing digital data of 1200 dpi at the ASIC timing of 1200 dpi. The ASIC 210 subsequently generates a first processed data of 600 dpi corresponding to the image of the first face of the document and a second processed data of 600 dpi corresponding to the image of the second face of the document.

In another embodiment, the output enable signals OEA and OEB control a selected number of data points of the first digital data Da1 and the selected number of data points of the second digital data Da2 to be alternately transmitted to the ASIC 210 and processed by the ASIC 210 in the sequence of, e.g. Da11, Da12, Da23, Da24, Da15, Da16, Da27, Da28, . . . , Da11197, Da11198, Da21199, Da21200. Or alternatively, the 600 data points of the first digital data Da2 can be transmitted to and processed by the ASIC 210 first before the 600 data points of the second digital data Da1.

The ASIC 210 processes the first digital data Da1 and the second digital data Da2 at the timing of 1200 dpi which is twice as the resolution of the first digital data Da1 and the second digital data Da2 (that is 600 dpi) transmitted to the ASIC 210, so a sum of the first data amount of the first digital data Da1 and the second data amount of the second digital data Da2 transmitted to ASIC 210 does not exceed the maximum data amount which the ASIC 210 is capable of processing at the ASIC timing of 1200 dpi. Therefore, the first digital data Da1 and second digital data Da2 generated in a duplex scan can be processed by using a single ASIC, thereby achieving the purpose of reducing the production costs.

Referring to FIG. 3 again, diagrams illustrating the output of the first and second digital data Da1 and Da2 controlled by the output enable signals OEA and OEB and the sequence of the first and second digital data Da1 and Da2 processed by the ASIC 210 according to the ASIC timing, according to the preferred embodiment of the invention, are shown. As shown in FIG. 3, the CCD timing T of 1200 dpi outputted by the ASIC 210 requests the CCDs 216 and 218 to generate analog data Di1 and Di2 of 1200 dpi. The first output enable signal OEA and the second output enable signal OEB are two out-of-phase signals. In this illustration, according to the output enable signals OEA and OEB, a number of selected data points of the first digital data Da1 and a number of selected data points of the second digital data Da2 are transmitted to the ASIC 210 in a low level L of the first output enable signal OEA and the second output enable signal OEB. In an alternative process, the data points of the first digital data Da1 and the second digital data Da2 may be transmitted to the ASIC 210 in a high level H of the first output enable signals OEA and the second output enable signal OEB. In this manner, only half of the data points of the first digital data Da1 and the second digital data Da2 are transmitted to the ASIC 210, that is 600 data point for each of the first digital data Da1 and the second digital data Da2.

Referring to FIG. 4, in another embodiment of a duplex scan to generate a scanned image of 600 dpi, the ASIC 210 outputs a CCD timing of 600 dpi to CCDs 216 and 218. The CCDs 216 and 218 according to the CCD timing generate a first analog data Di1 of 600 dpi and a second analog data Di2 of 600 dpi. Assuming that each scan line contains 600 data points at 600 dpi, each of the first analog data Di1 and the second analog data Di2 is constituted by 600 data points. The first AFE 212 and the second AFE 214 convert the analog data Di1 and Di2 of 600 dpi into the first digital data Da1 of 600 dpi and the second digital data Da2 of 600 dpi respectively. The first digital data Da1 of 600 dpi and the second digital data Da2 of 600 dpi are transmitted to the ASIC 210 without using the first output enable signal OEA and the second output enable signal OEB. The ASIC 210 processes the first digital data Da1 of 600 dpi and the second digital data Da2 of 600 dpi at the ASIC timing of 1200 dpi, in another words, the CCD timing equals half of the ASIC timing so as to generate the scanned image of 600 dpi without using the signals OEA and OEB.

The duplex scan apparatus according to the above-mentioned embodiments of the invention has the following advantages. By using a single ASIC to simultaneously process the image data generated in duplex scan and using the signals OEA and OEB to control the data output process of the first digital data Da1 and the second digital data Da2 by the first AFE and the second AFE. By such configuration, at least 20% of material costs on the circuit board can be saved and the production efficiency can be increased.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A duplex scan apparatus, for simultaneously scanning a first face and a second face of a to-be-scanned document to generate scanned images of a selected resolution, the duplex scan apparatus comprising:
an application specific integrated circuit (ASIC), for processing digital data at an ASIC timing and outputting a CCD timing, wherein the ASIC timing equals twice as the selected resolution;
a first charge-coupled device (CCD), controlled by the ASIC, for scanning the first face of the to-be-scanned document and generating first analog data according to the CCD timing outputted by the ASIC;
a second CCD, controlled by the ASIC, for scanning the second face of the to-be-scanned document and generating second analog data according to the CCD timing outputted by the ASIC;
a first analog front end (AFE), coupled with the first CCD and the ASIC, for converting the first analog data into first digital data and outputting a first data amount of data points of the first digital data to the ASIC for processing; and
a second AFE, coupled with the second CCD and the ASIC, for converting the second analog data into second digital data and outputting a second data amount of data points of the second digital data to the ASIC for processing.

2. The duplex scan apparatus according to claim 1, wherein the CCD timing equals the ASIC timing.

3. The duplex scan apparatus according to claim 2, wherein the ASIC further outputs a first output enable signal and a second output enable signal to enable the first AFE and the second AFE to alternately transmit the data points of the first data amount of the first digital data and the data points of the second data amount of the second digital data at the ASIC timing to the ASIC respectively.

4. The duplex scan apparatus according to claim 3, wherein odd-numbered data points of first digital data and even-numbered data points of second digital data are alternately transmitted to the ASIC according to the first output enable signal and the second output enable signal respectively and processed by the ASIC in sequence.

5. The duplex scan apparatus according to claim 3, wherein a selected number of data points of the first digital data and the selected number of data point of the second digital data are alternately transmitted to the ASIC according to the first output enable signal and the second output enable signal respectively and processed by the ASIC in sequence.

6. The duplex scan apparatus according to claim 3, wherein the first data amount of the first digital data are transmitted to the ASIC after the second data amount of the second digital data according to the first output enable signal and the second output enable signal respectively.

7. The duplex scan apparatus according to claim 3, wherein the first output enable signal and the second output enable signal are two out-of-phase signals.

8. The duplex scan apparatus according to claim 7, wherein the first data amount of the first digital data and the second data amount of the second digital data are transmitted to the ASIC in a low level of the corresponding first output enable signal and the second output enable signal.

9. The duplex scan apparatus according to claim 7, wherein the first data amount of the first digital data and the second data amount of the second digital data are transmitted to the ASIC in a high level of the corresponding first output enable signal and the second output enable signal.

10. The duplex scan apparatus according to claim 1, wherein the CCD timing equals half of the ASIC timing.
